(19) United States
(12) Patent Application Publication
(10) Pub. No.: US 2024/0216829 A1
(43) Pub. Date: Jul. 4, 2024

(54) CENTRIFUGATION STATION FOR EXTRUSION PLANTS

(71) Applicant: VB SOLUZIONI E TECNOLOGIE S.R.L., Milano (IT)

(72) Inventors: Marco ROVELLINI, Piacenza (IT); Giovanni PINGANI, Ravenna (IT)

(21) Appl. No.: 18/558,274

(22) PCT Filed: Jun. 7, 2021
(86) PCT No.: PCT/IB2021/054964

§ 371 Date: Oct. 31, 2023

(30) Foreign Application Priority Data
May 11, 2021 (IT) 102021000012026

(51) Int. Cl. B01D 1/22; B01D 1/00; B29C 48/76; B29C 48/92

(52) U.S. Cl. CPC B01D 1/225; B01D 1/0082; B29C 48/765; B29C 48/92

(57) ABSTRACT

A centrifugation station for extrusion plants comprises a tubular body, a shaft and an impeller. The tubular body internally defines a processing duct extending along a central axis between a supply section and a release section. The shaft has an upper portion extending in the supply section and a threaded lower portion extending in the release section. The impeller is fitted around the upper portion of the shaft and is rotatable around the central axis independently of the shaft. Furthermore, the impeller is provided with a plurality of blades angularly spaced from each other and shaped to distribute the molten material to be extruded on an inner wall of the supply duct favouring the extraction of any volatile compounds from the material to be extruded.

The present invention relates to the field of production processes performed by means of extrusion.

In particular, the present invention relates to a centrifugation station installable in an extrusion plant for the processing of polymeric materials, in particular and preferably for the manufacture of polymers intended for the production of synthetic fibres and for the direct production of synthetic fibres for the textile industry.

Different extrusion techniques of polymers exploiting extrusion systems, typically single or double cochlea, are known in the prior art, where the polymer is extruded in several stages, generally three, one of supplying/melting/softening of the polymers in incoherent form, one of compression and one of volumetric dosage, in which the molten or softened polymer is pushed towards a further device, typically a tube or a matrix.

In order to improve the quality of the final product, in the most cutting-edge solutions the extruders are provided with sections, usually interposed between the first and the third stage, which facilitate the extraction of possible impurities, with low molecular weight or volatile, from the polymer structure.

In one of such solutions, a double co-rotating parallel cochlea extruder is used, in which the joint action of the elements of each screw/cochlea performs an intense mechanical action on the molten polymer, helping the release of impurities; the arrangement of one or more suction mouths along the peripheral mantle of the extruder allows the interception and removal of the volatile compounds released by agitation, increasing the quality of the polymer to be spun.

Disadvantageously, such a solution is all the more effective in the removal of impurities the greater the mechanical action of hammering and fragmentation performed by the two cochleas (thus the greater the rotation speed thereof), which impacts negatively on the mechanical and structural properties of the polymer.

Another possible solution includes the use of a single-screw extruder provided with a special volatile compound extraction station interposed between the melting and extrusion stages.

In this context, the extraction station usually has a very particular conformation, provided with a plurality of high-speed rotating screws, angularly spaced apart and individually arranged within a respective longitudinal duct.

The presence of single high-speed rotatable screws close to small ducts facilitates the constant renewal of the outer surface of the molten mass, promoting the separation between high and low molecular weight components.

In addition, at a predetermined section of the ducts, there are also suction mouths, more specifically radial suction mouths, from which the volatile components removed by the action of the screws are extracted.

Disadvantageously, also the solution just described has drawbacks related to both the suction location and the shaking/extraction action.

In fact, the presence of a plurality of rotating screws at different speeds from that of the extruder entails the necessity to include a complex system of transmissions or independent actuations and greatly increases the complexity and cost of the system.

Furthermore, the positioning of one or more radial suction mouths at certain points in the plant greatly limits the ability to extract impurities, since the vacuum action is only maximum by the mouth, but increasingly loses effectiveness with the distancing therefrom.

It is therefore evident that devices of the known art are still affected by problems and disadvantages which make the use thereof unsatisfactory and therefore the need for new tools of greater effectiveness and efficiency is strongly felt in the field.

An object of the present invention is therefore to provide a centrifugation station for an extrusion plant which overcomes the drawbacks of the prior art cited above.

In particular, an object of the present invention is to provide a centrifugation station for processing materials to be extruded which is capable of efficiently removing impurities without compromising the quality thereof.

The technical task mentioned and the objects stated are substantially achieved by a centrifugation station for extrusion plants, comprising the technical features set out in one or more of the appended claims.

According to the present invention, a centrifugation station is shown.

In particular, the present invention relates to a centrifugation station for extrusion plants.

Essentially the station comprises a tubular body, a shaft, and an impeller.

The tubular body internally defines a processing duct extending along a central axis between a supply section and a release section.

The supply section defines an inlet of a material to be extruded in molten form into the processing duct.

The release section instead contributes to defining an outlet nozzle of the material to be extruded.

The shaft has an upper portion extending along the supply section and a threaded lower portion, which defines an endless screw.

In particular, the threaded lower portion extends in the release section and is configured to promote the exit of the material from the outlet nozzle.

Preferably, the threaded lower portion is configured to exert a thrust action on the material to be extruded received from the supply section.

The impeller is fitted around the upper portion of the shaft.

Furthermore, the impeller is rotatable around the central axis independently of the shaft.

The impeller is provided with a plurality of blades angularly spaced/spaced apart from each other and shaped to distribute the molten material to be extruded on an inner wall of the supply duct favouring the extraction of any volatile compounds from the material to be extruded.

Advantageously, the station described herein has a structure which allows the impeller to be decoupled from the shaft, providing the possibility of independently controlling the operating speed, in particular the rotation speed, of the shaft and the impeller.

The dependent claims, included here by reference, correspond to different embodiments of the invention.

Further features and advantages of the present invention will become more apparent from the description of an exemplary, but not exclusive, and therefore non-limiting preferred embodiment of a centrifugation station, as illustrated in the appended figures, in which:

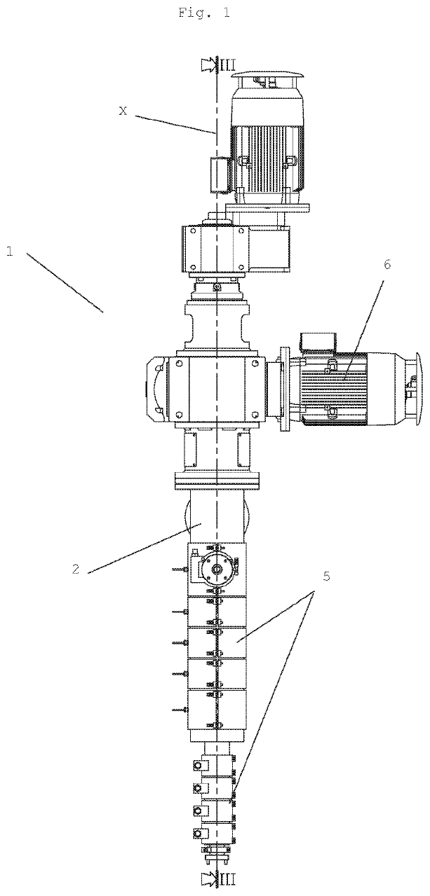

FIG. 1 shows a centrifugation station according to the present invention;

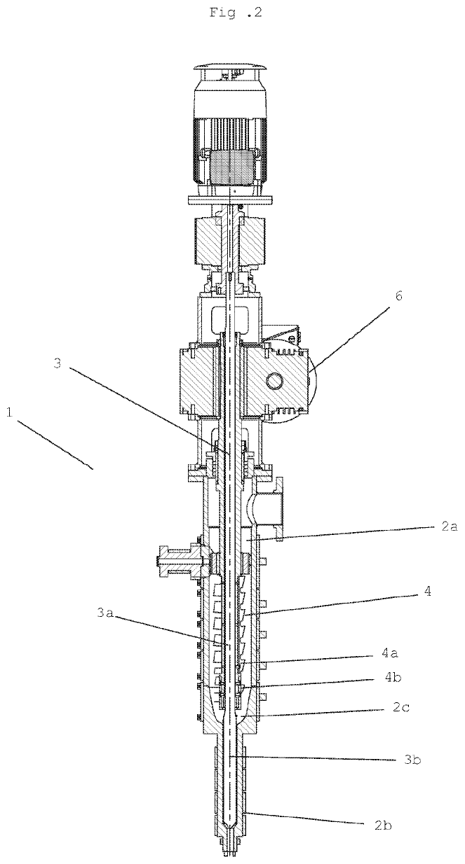

FIG. 2 shows a section of the station of FIG. 1;

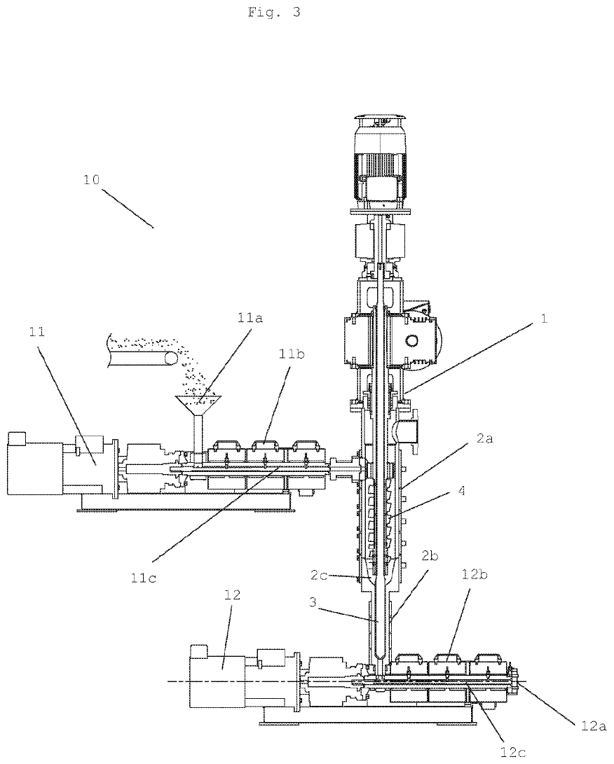

FIG. 3 shows an extrusion plant on which the station of FIG. 1 is installed.

Referring to the accompanying figures, the reference numeral 1 overall indicates a centrifugation station, which is referred to in the following description simply as station 1.

In detail, the station 1 is configured to be installed in an extrusion plant 10 assigned to process materials to be extruded and whose structure will be further described below.

For the purposes of the present description, the generic term “material to be extruded” refers to any known material suitable to be used in the field of extrusion processes, for example plastics, polymers or other materials.

By way of non-limiting example, the processable materials to be extruded can be originally heterogeneous in terms of size distribution and can comprise powders mixed with pellets and/or pellets of various diameters.

For example, the plant 10 can work to process powdered or granulated materials or materials available in the state of aggregation under the guise of so-called “pellets” or similar bodies or still more generally in different forms such as pieces under the guise of “bars” or “ingots” or “chunks” or “large flakes”.

Also, by way of example, the heterogeneous materials in terms of morphological distribution can also comprise lenticular granules, scales, flakes, etc.

In general, such materials are supplied to the plant in the form of discrete elements and then, by means of appropriate heating processes, brought into a molten/fluid configuration which allows the modelling thereof to create semi-finished and finished products.

Subsequently, the materials to be extruded are transferred to the station 1 in the molten configuration thereof and undergo processes therein which allow in particular to improve the overall quality of the product that can be produced with such materials.

From a structural point of view, the station 1 comprises a tubular body 2, a shaft 3 and an impeller 4.

The tubular body 2 represents the load-bearing structure of the station 1 and defines therewithin a processing duct extending along a central axis X (which also represents an axis of symmetry of the tubular body 2) between a mutually communicating supply section 2a and a release section 2b.

In other words, the tubular body 2 has therein a first portion, i.e., the supply section 2a, and a second portion, i.e., the release section 2b, which effectively represents a continuation of the supply section 2a.

In more detail, the supply section 2a defines an inlet for the material to be extruded inside the tubular body 2, i.e., the station 1 is interfaced with further components of the extrusion plant located upstream and from which it receives the material to be extruded.

Specifically, the station 1 receives the material to be extruded in molten form through the supply section 2a thereof from the upstream processes and components.

At the same time, the release section 2b instead represents an outlet of the material to be extruded from the tubular body 2 and contributes to defining a nozzle through which the material to be extruded is ejected from the tubular body 2, so that it can be supplied to further devices/processes of the plant 10 located downstream of the station 1.

Overall, therefore, it appears that the material to be extruded is introduced into the tubular body 2 by means of the supply section 2a, flows along the processing channel and is finally made to exit from the tubular body by means of the release section 2b thereof.

The exit of the material to be extruded from the tubular body 2 is favoured by the shaft 3 arranged along the central axis, which has an upper portion 3a, preferably smooth, which extends along the supply section 2a and a threaded lower portion 3b which instead extends along the release section 2b.

In particular, the threaded lower portion 3b defines a worm screw which, when the shaft 3 is rotated, favours the advancement of the material to be extruded towards the outlet of the processing duct and the exit thereof through the nozzle.

Along the path leading from the supply section 2a to the release section 2b, the material to be extruded is further processed in particular for the purpose of operating a removal of any volatile compounds.

Such a process is made possible by the presence of the impeller 4 which is fitted around the upper portion of the shaft 3.

In other words, the shaft 3 and the impeller 4 are coaxial and both extend inside the processing channel along the central axis X, with the impeller 4 arranged in the supply section 2a (where it can immediately engage the material to be extruded entering the station 1) and the shaft 3 having the upper portion arranged inside the impeller 4 and the threaded lower portion 3b positioned in the release section 2b, where it can assist and promote the ejection of the material to be extruded after the latter has been processed by the impeller 4.

Structurally, the impeller 4 is provided with a plurality of blades angularly spaced from each other and shaped to distribute the molten material to be extruded on an inner wall of the supply duct, thus favouring the extraction of any volatile compounds from the material to be extruded.

The blades can be monolithic, each extending along the useful length of the impeller 4 or, as in the illustrated embodiment, discrete and defined by a sequence of individual elements arranged in sequence along the central axis “X”.

Each blade (or each individual element) of the impeller 4 preferably extends between a radially inner portion, proximal to the central axis “X”, and a radially outer portion, proximal to the inner wall of the tubular body 2.

More specifically, the radially outer portion of the blades has an end spaced from the inner wall by a gap defining the thickness of the layer of polymeric material “spread” on the same inner wall.

Preferably, the distance between the end of the radially outer portion of the blade and the inner tubular wall of the tubular body 2 is less than 10 mm, more preferably between 1 and 3 mm.

Advantageously, thereby the rotation of the impeller 4 together with the space lying between the end of the blade and the tubular body 2 causes the molten (or softened) polymeric material to be directed and distributed on the inner wall.

Preferably, furthermore, the impeller 4 is configured so that the volume contained between two adjacent blades and the stretch of inner wall interposed therebetween is substantially free, except for the layer of molten polymeric material spread on the inner wall itself.

In other words, the impeller 4 is shaped so that between two adjacent blades there is a free volume at the radially inner zone of the tubular body 2, thereby going to define an escape route for the volatile components released from the material to be extruded during the centrifugation.

Thus, the centrifugation station 1 is configured to extract the volatile compounds of the polymeric material to be extruded from a central, i.e., radially inner, zone of the tubular body 2.

Overall, it therefore results that the tubular body 2 and the impeller 4 contribute to defining a thin-film evaporator in which the material to be extruded is received inside the tubular body 2 and released from the volatile components by means of the centrifugation action exerted by the impeller 4, which spreads a thin film of material to be extruded on the inner surface of the tubular body 2.

Furthermore, the impeller 4 is rotationally autonomous with respect to the shaft 3.

Thereby, it is possible to autonomously and independently manage the rotation speed of the impeller 4 and the shaft 3.

Such a feature allows the station 1 to be operated simultaneously at a speed such as to optimize both the process of extracting volatile components and that of supplying the material to be extruded to the downstream devices/processes.

In fact, the impeller 4 can be moved at a high speed particularly adapted to favour the removal of volatile components, but which would damage the material to be extruded if also applied to the shaft 3 to convey it to the outlet of the station 1, and the shaft 3 can instead be moved at a lower speed particularly adapted to move the material to be extruded without mechanically damaging it, but which would be inefficient if applied to the impeller 4 to perform the removal of volatile compounds.

Operatively, the movement of the shaft 3 and the impeller 4 is carried out by an actuator unit, which is specifically configured to rotate the impeller 4 and the shaft 3 at different rotation speeds.

In the preferred embodiment, the actuator unit is configured to move the impeller 4 with a rotation speed between 100 and 500 rpm, more preferably between 110 and 250 rpm, still more preferably between 130 and 200 rpm.

In the same context, the actuator unit is configured to move the shaft 3 with rotation speeds between 8 and 100 rpm, more preferably between 15 and 80 rpm.

In general, the shaft 3 is moved at a lower rotation speed than the rotation speed of the impeller 4.

According to an aspect of the present invention, the supply section 2a and the release section 2b have respective substantially cylindrical shapes having different diameters.

Specifically, the supply section 2a has a larger diameter than that of the release section 2b.

In fact, the greater diameter allows to increase the surface on which it is possible for the impeller 4 to spread the material to be extruded, increasing the amount of material which can be processed in the unit of time.

At the same time, the release section 2b preferably has a section equal to the overall dimensions of the threaded lower portion 3b so that the thread can, during the rotation thereof, scrape against the inner wall of the release section 2b thus ensuring the correct release of all the material to be extruded, preventing it from accumulating inside the tubular body 2.

In this context, the processing duct further has a variable-diameter connecting section 2c interposed between the supply section 2a and the release section 2b.

In other words, the connecting section connects the supply section 2a to the release section 2b having a diameter which progressively narrows in the direction thereof.

As can be seen in the attached figures, the trend of the diameter of the connecting section 2c is such as to give it a substantially cup-shaped form which promotes the sliding of the material to be extruded in the direction of the release section 2b.

To further promote the transfer of the material to be extruded to the release section 2b, thereby allowing the engagement by the threaded lower portion 3b, such threaded lower portion 3b can extend partially inside the connecting section 2c.

Furthermore, the upper portion 3a of the shaft 3 and the impeller 4 fitted thereon also extend at least partially inside the connecting section 2c.

Thereby, the blades arranged at the connecting section 2c can assist the transfer of the material to be extruded by pushing it towards the release section 2b until it is engaged by the threaded lower portion 3b of the shaft 3.

In detail, the impeller 4 can have a first portion extending entirely along the supply section 2a and a second portion extending at least in part in the connecting section 2c.

The blades of the second portion have a different shape and/or size with respect to the blades of the first portion.

In other words, the impeller 4 comprises first blades 4a arranged entirely along the supply section 2a and having a shape and dimensions specifically configured to spread the material to be extruded on the inner surface of the tubular body 2 and second blades 4b which are arranged at least in the connecting section 2c (but can also extend at least partially in the supply section 2a) and having a shape and dimensions specifically configured to assist the sliding of the material to be extruded in the direction of the release section 2b.

In particular, the second blades can be smaller than the first blades 4a, as they do not need to spread the material to be extruded on the inner wall of the processing channel.

In order to keep the consistency of the material to be extruded malleable when it is inside the processing channel, the station 1 further comprises thermo-regulating means 5, for example resistive bodies or ducts for liquids or gases, active on the inner wall of the tubular body 2, at least at the supply section 2a, and configured to change the temperature thereof or keep the temperature within a certain range (or around a predetermined value), so as to adjust the temperature of the material to be extruded.

Such a value or temperature range is a function of the type of polymeric material treated, as the entity thereof is linked to the melting or softening temperature of the material to be extruded to be maintained during the centrifugation step.

Preferably, the thermo-regulating means 5 are configured to keep the inner wall of the tubular body 2 and/or the materials to be extruded at temperatures between 200 and 350° C., more preferably between 230 and 310° C.

According to an aspect of the invention, the station 1 further comprises at least one suction unit 6 configured to suck the volatile compounds from the radially inner zone of the processing channel.

Preferably, the suction unit 6 comprises a vacuum generating device placed in fluid connection with a suction mouth arranged coaxially with the tubular body 2.

The vacuum generating device is preferably configured to generate a vacuum which brings the pressure value below 20 mbar, preferably below 10 mbar, more preferably between 1 and 8 mbar.

In the preferred embodiment, the suction unit 6 is located near the supply section 2a.

In the illustrated embodiment, i.e., when the tubular body 2 is arranged vertically, the suction mouth is positioned at a higher height than the supply section 2a.

Advantageously, thereby, the suction of the volatiles acts in counter-current with respect to the advancement, by falling, of the polymeric material.

Preferably, such a suction mouth is provided with a filter sized to prevent solid/liquid particles of the polymeric material from clogging the suction unit.

In other words, the filter is interposed between the impeller 4 at which the ejection of the volatile compounds occurs and the vacuum generating device, preferably the filter is defined by a predefined mesh or a layer of filtering material.

Advantageously, the present invention achieves the proposed objects by overcoming the drawbacks lamented in the prior art by providing the user with a particularly efficient and effective centrifugation station which allows to simultaneously optimize the centrifugation and supply processes of the material to be extruded to the further devices/processes of the extrusion plant on which such a station is installed.

The object of the present invention is also an extrusion plant, indicated in the attached figures as a plant 10.

In particular, the plant 10 according to the invention finds application in the manufacture of synthetic fibres or polymers intended for the production of synthetic fibres from a predetermined quantity of material, originally in the forms indicated above, to be extruded.

The material to be extruded, which can also be recycled, is preferably polyester or polyamide, but could also be of another type if necessary.

Structurally, the plant 10 described herein comprises at least one supply station 11, at least one outlet station 12 and a centrifugation station 1 having one or more of the technical features described above.

The supply station 11 is configured to receive a material to be extruded in loose form and to heat it above a predetermined melting or softening temperature so as to make it malleable and fluid.

Preferably, the supply station 11 has a receiving section 11a of the polymeric material in inconsistent form, defined for example by a hopper or a funnel, and a heating unit 11b, achievable with modalities similar to those of the thermo-regulating means active on the centrifugation station 1, configured to raise the temperature of the melting station 11.

In particular, the heating unit is configured to heat a containment zone of the material to be extruded, so as to bring it above a predetermined melting or softening temperature.

The supply station 11 further comprises a thrust member 11c (e.g., a screw or auger) configured to promote the transfer of the material to be extruded in the molten state to the centrifugation station 1.

Within the centrifugation station 1, volatile compounds can be removed from the material to be extruded in the manner discussed above.

At the end of the centrifugation process, the material to be extruded is then transferred under the action of the threaded lower portion 3b of the shaft 3 to the outlet station 12.

In general, the outlet station 12 is configured to convey the material to be extruded to further processing processes/devices which are also an integral part of the plant 10 or external thereto.

Such further processes/devices can comprise for example a die, an extrusion head, a gear pump, a filter or a cutter.

In particular, the outlet station 12 can simply comprise a tubular element within which the material flows under the thrust exerted by the shaft 3 of the centrifugation station 1 until the further process/device is reached or even only define a passage and/or interface portion between the centrifugation station 1 and the further process.

Advantageously, the outlet station 12 can also comprise a thrust member 12c, also defined by a screw or auger of appropriate size, configured to further push the material to be extruded towards the further downstream processes.

In the specific configuration shown by way of example in FIG. 3, the outlet station comprises the thrust member 12c which favours the movement of the material to be extruded received from the centrifugation station 1 to make it exit from a nozzle 12a located at an outlet of the tubular element which contributes to defining the overall structure of the outlet station 12.

In general, within the outlet station 12, the material to be extruded can also continue to be maintained in a sufficiently melted and malleable configuration by appropriate heating means 12b which can also be made in similar manners and corresponding to the thermo-regulating means 5.

1. A centrifugation station for extrusion plants comprising:
a tubular body internally defining a processing duct extending along a central axis between a supply section defining an inlet of a material to be extruded in molten form and a concurrent release section defining an outlet nozzle of said material to be extruded;
a shaft having an upper portion extending in said supply section and a threaded lower portion defining an endless screw extending in said release section and configured to promote the exit of the material from the outlet nozzle;
an impeller fitted around the upper portion of the shaft and rotatable around said central axis independently of the shaft, said impeller being provided with a plurality of blades angularly spaced from each other and shaped to distribute the molten material to be extruded on an inner wall of the supply duct favouring the extraction of any volatile compounds from the material to be extruded.

2. The station according to claim 1, comprising an actuator unit configured to rotate the impeller and the shaft at different rotation speeds.

3. The station according to claim 1, wherein the actuator unit is configured to move the impeller with a rotation speed between 100 and 500 rpm and to move the shaft with a rotation speed between 8 and 100 rpm.

4. The station according to claim 1, wherein each blade of the impeller extends between a radially inner portion, proximal to the central axis, and a radially outer portion, proximal to the inner wall of the processing duct; said impeller being shaped so that the volume contained between two adjacent blades and the inner wall portion interposed therebetween is substantially free, except for a layer of material to be extruded spread on said inner wall.

5. The station according to claim 1, wherein the supply section and the release section have respective substantially cylindrical shapes having different diameters, said processing duct further having a variable-diameter connecting section interposed between the supply section and the release section.

6. The station according to claim 5, wherein the upper portion of the shaft and the impeller extend along at least one stretch of the connecting section.

7. The station according to claim 6, wherein the impeller has:
a first portion extending entirely in the supply section;
a second portion extending at least partly in the connecting section;
wherein the blades of the second portion have a different shape and/or size with respect to the blades of the first portion.

8. The station according to claim 1, comprising thermo-regulating means coupled to the tubular body and active at least on the supply section to regulate a temperature of the material to be extruded.

9. The station according to claim 1, wherein said tubular body and said impeller at least partly define a thin-film evaporator.

10. The station according to claim 1, comprising at least one suction unit configured to suck said volatile compounds from the processing duct.

11. An extrusion plant comprising:
at least one supply station configured to receive a material to be extruded in loose form and to heat it above a predetermined melting or softening temperature;
at least one outlet station configured to convey the molten or softened material to be extruded to further processing processes
a centrifugation station according to claim 1 interposed between the supply station and the outlet station.
